(19) United States
(12) Patent Application Publication
(10) Pub. No.: US 2026/0100486 A1
(43) Pub. Date: Apr. 9, 2026

(54) METAL MEMBER, AND ELECTRODE TERMINAL AND POWER STORAGE MODULE INCLUDING METAL MEMBER

(71) Applicant: Prime Planet Energy & Solutions, Inc., Tokyo (JP)

(72) Inventor: Shota TAKEBE, Nagoya-shi (JP)

(21) Appl. No.: 19/348,790

(22) Filed: Oct. 3, 2025

(30) Foreign Application Priority Data
Oct. 9, 2024 (JP) 2024-177425

(51) Int. Cl. H01M 50/516; H01M 50/566

(52) U.S. Cl. CPC H01M 50/516; H01M 50/566

(57) ABSTRACT

Provided is a technology for reducing the risk of molten metal splattering when welding a metal member including a first member made of metal and a second member made of metal, which are laid on top of each other, to another metal member. The metal member disclosed herein includes the first member made of metal and the second member made of metal. The second member has a space, in which gas can accumulate, between the first member and the second member. The second member has a ventilation hole that communicates the space with outside air.

### CROSS REFERENCE TO RELATED APPLICATION

The present application claims the priority based on Japanese Patent Application No. 2024-177425 filed on Oct. 9, 2024, the entire contents of which are incorporated in the present specification by reference.

### BACKGROUND OF THE DISCLOSURE

### 1. Field

The present disclosure relates to a metal member, and an electrode terminal and a power storage module including the metal member.

### 2. Background

In recent years, secondary batteries, such as lithium-ion secondary batteries, and power storage modules including secondary batteries have become increasingly widespread. Secondary batteries and power storage modules including secondary batteries are suitably used, for example, as power sources for vehicle propulsion in electric vehicles (BEVs), hybrid vehicles (HEVs), and plug-in hybrid vehicles (PHEVs).

Japanese Patent Application Publication No. 2001-87879 discloses a laser welding method in which target materials that are laid on top of each other are irradiated with laser light to melt them and join them together. In this method, holes with a diameter smaller than the intended joint diameter are formed in advance in target materials other than the target material that is first irradiated with the laser light. Then, laser light with a diameter larger than the diameter of these holes is irradiated at positions corresponding to the holes in the target materials where no hole has been formed, to melt and join the target materials.

Japanese Patent Application Publication No. 2001-87879 also states that the holes are ventilation holes for releasing gas. Therefore, if impurities exist between the target materials, the vapor generated when the impurities evaporate due to the welding heat can escape through the holes. According to such a configuration, good welding conditions can be achieved, thereby realizing sufficient joint strength.

Japanese Patent Application Publication No. 2019-166533 discloses a structure of laser overlay welding, which is achieved by irradiating laser light to join a first member disposed on a side facing the laser light irradiation side and a second member laid on top of the first member on the side opposite to the irradiation side of the first member. The first member has at least one through hole portion formed in the direction in which the second member is laid on top of the first member. The first member and the second member are joined by welded portions extending from an overlay region in which the first member and the second member are laid on top of each other and are in contact with each other, to a through region where the through hole portion is projected onto the second member, including a portion of the boundary between the overlay region and the through region. Japanese Patent Application Publication No. 2019-166533 also states that this configuration provided improved joint strength between the overlaid members.

Japanese Patent Application Publication No. 2020-19061 discloses a method for manufacturing a joint structure including a first member made of a plated iron-based material and a second member made of a material different from that of the first member. This method includes the steps of forming an insertion hole in the second member; overlaying the first member and the second member such that the insertion hole opposes the first member; inserting an insertion member made of an iron-based material and having an insertion portion and a non-insertion portion, and having a through hole extending from the insertion portion to the non-insertion portion, into the insertion hole of the second member until the insertion member comes into contact with the first member; and forming a welded metal portion at a contact portion between the first member and the insertion member to join the first member and the insertion member. Japanese Patent Application Publication No. 2020-19061 also states that, with this configuration, the first member, which is made of a plated iron-based material, and the second member, which is made of a material different from that of the first member, can be joined in a gap-free, pore-free, and sound state.

### SUMMARY

When welding a metal member including a first member made of metal and a second member made of metal, which are laid on top of each other, to another metal member, if there is a space between the first member and the second member where gas can accumulate, for example, the gas in the space may expand due to the heat applied during welding. This gas may cause the molten metal to splatter onto the surrounding area. When molten metal splatters, the weld quality between the metal member and the other member may be impaired, which is undesirable.

The present disclosure has been made in view of this point, and an object thereof is to provide a technology for reducing the risk of molten metal splattering when welding a metal member including a first member made of metal and a second member made of metal, which are laid on top of each other, to another metal member.

According to the technology disclosed herein, a metal member is provided. The metal member includes a first member made of metal and a second member made of metal. The second member has a space, in which gas can accumulate, between the first member and the second member. The second member has a ventilation hole that communicates the space with outside air. According to such a configuration, when welding a metal member comprising a first member made of metal and a second member made of metal, which are laid on top of each other, and another metal member, the risk of molten metal splattering can be reduced.

According to the technology disclosed herein, an electrode terminal for use in a power storage device is provided. The electrode terminal includes the metal member. With this configuration, when welding the metal member to another metal member, the risk of molten metal splattering can be reduced. As a result, the welding quality between the electrode terminal and another member can be improved.

According to the technology disclosed herein, a power storage module including an electrode terminal and a busbar is provided. The power storage module includes the metal member. The electrode terminal includes the first member and the second member. The busbar includes a third member. According to such a configuration, when welding the electrode terminal and the busbar together, the risk of molten metal splattering can be reduced. As a result, a power storage module with improved welding quality between the electrode terminals and the busbar can be constructed.

### BRIEF DESCRIPTION OF THE DRAWINGS

FIG. 1 is a perspective view of a power storage module 100;

FIG. 2 is a cross-sectional view of FIG. 1 taken along the II-II line; and

FIG. 3 is a view of a busbar 14 as viewed from an upper face 141.

### DESCRIPTION OF THE EMBODIMENTS

Now, an embodiment of the power storage device disclosed herein will be described. The embodiment described herein is not intended to limit the technology disclosed herein. The technology disclosed herein is not limited to the embodiments described herein unless otherwise specified. The drawings are schematic and may not necessarily reflect the actual object. Members or parts that perform the same function may be designated by the same reference numeral, and redundant descriptions may be omitted. The symbols “R,” “L,” “U,” “D,” “F,” and “Rr” in the drawings indicate “right,” “left,” “up,” “down,” “front,” and “rear,” respectively. The notation “A to B” indicating a numerical range means “between A and B” unless otherwise specified, and also includes the meaning “exceeding A and falling below B.”

Herein, “power storage device” refers to a device in which charging and discharging occur through the movement of charge carriers between a pair of electrodes (positive electrode and negative electrode) via an electrolyte. Power storage devices include secondary batteries such as lithium-ion secondary batteries, nickel-metal hydride batteries, and nickel-cadmium batteries, and capacitors such as lithium-ion capacitors and electric double-layer capacitors. The power storage device may, for example, be a lithium-ion secondary battery.

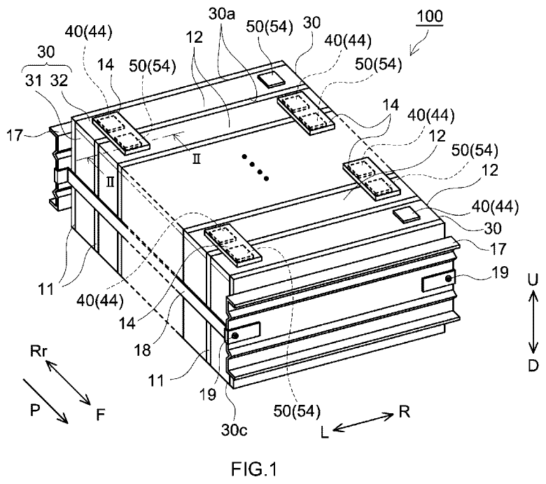

FIG. 1 is a perspective view of a power storage module 100. As shown in FIG. 1, the power storage module 100 includes power storage devices 12 and a busbar 14. As shown in FIG. 1, each power storage device 12 is arranged such that first faces 30a of the power storage devices 12 oppose one another. Here, the power storage devices 12 are arranged in the direction from one first face 30a to the other first face 30a of each power storage device 12. The direction in which the power storage devices 12 are arranged is from the rear (Rr) side to the front (F) side in FIG. 1. Hereinafter, the direction in which the power storage devices 12 are arranged is also referred to as an “arrangement direction P. ”

In the configuration shown in FIG. 1, the power storage device 12 includes a rectangular case 30, the pair of opposing first faces 30a, a pair of opposing second faces 30b, and a bottom face 30c. The first face 30a is rectangular and is the largest face of the case 30. As shown in FIG. 1, the opposing pair of first faces 30a are faces extending from an opposing pair of long sides of the bottom face 30c. The second face 30b is rectangular and is a face sandwiched between the opposing pair of first faces 30a. As shown in FIG. 1, the opposing pair of second faces 30b are faces extending from an opposing pair of short sides of the bottom face 30c.

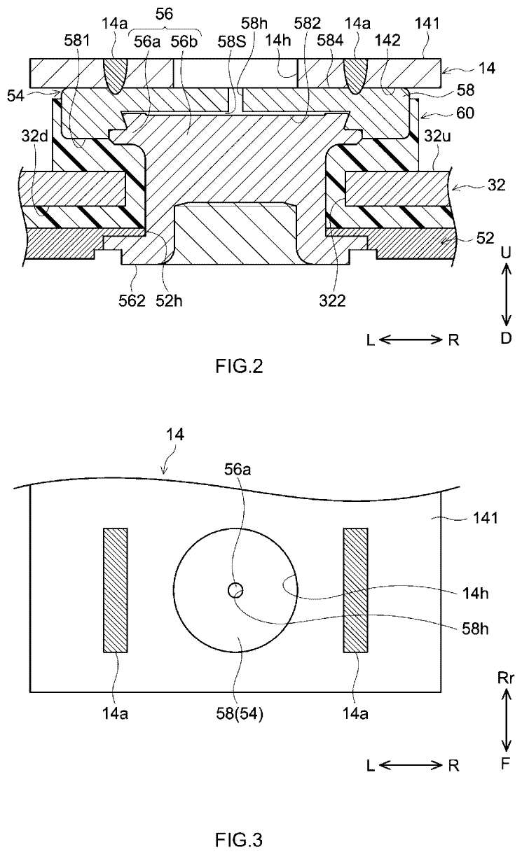

The storage device 12 includes, for example, the case 30, an electrode body (not shown) accommodated within the case 30, and an electrolyte (not shown). The case 30 includes a main body 31 and a sealing plate 32, as shown in FIG. 1. The main body 31 is, for example, a member that accommodates the electrode body and the electrolyte. In this embodiment, the main body 31 has a rectangular prism shape with one face open. In the configuration shown in FIG. 1, the main body 31 includes the pair of opposing first faces 30a, the pair of opposing second faces 30b, and the bottom face 30c. Here, the bottom face 30c and the opening oppose each other. The sealing plate 32 is a member that seals the opening of the main body 31. The sealing plate 32 has a shape corresponding to the opening of the main body 31 and is rectangular (including approximately rectangular shapes; the same applies hereinafter). The sealing plate 32 has a first through hole (not shown) and a second through hole 322 (see FIG. 2). In this embodiment, the first through hole is a through hole through which a positive terminal 40 is inserted. The second through hole 322 is a through hole through which a negative terminal 50 is inserted. Note that the electrode body and the electrolyte of the power storage device 12 may be any electrode body and any electrolyte used in such a storage device (e.g., lithium-ion secondary battery) without particular restriction.

In this embodiment, in the power storage device 12, the positive terminal 40 and the negative terminal 50 are provided in the case 30. In the configurations shown in FIGS. 1 and 2, the positive terminal 40 and the negative terminal 50 are attached to the sealing plate 32. The negative terminal 50 will be described first.

FIG. 2 is a cross-sectional view of FIG. 1 taken along the II-II line. FIG. 2 shows an enlarged view of the cross-section near the connection between the busbar 14 and the negative terminal 50. As shown in FIG. 2, the negative terminal 50 includes a negative electrode current collecting terminal 52 and a negative external terminal 54. The negative electrode current collecting terminal 52 is a member connected to the negative electrode of an electrode body (not shown). In this embodiment, the negative electrode current collecting terminal 52 is plate-shaped. The negative electrode current collecting terminal 52 is arranged along an inner face 32d of the sealing plate 32. The negative electrode current collecting terminal 52 is connected to the negative electrode of the electrode body via a current collecting plate (not shown). The negative electrode current collecting terminal 52 has a through hole 52h. In this embodiment, the negative electrode current collecting terminal 52 is connected to the negative external terminal 54 by inserting a portion of the negative external terminal 54 into the through hole 52h. The negative electrode current collecting terminal 52 may be made of copper or a copper alloy (an alloy containing at least 70 mass % copper based on the total ingredients, the same applies hereinafter).

The negative external terminal 54 is, for example, a portion connected to the busbar 14. In this embodiment, the negative external terminal 54 includes a portion disposed inside the case 30, and a portion disposed outside the case 30. As shown in FIG. 2, the negative external terminal 54 includes a first member 56 and a second member 58. The first member 56 is, for example, a portion connected to the negative electrode current collecting terminal 52. In this embodiment, the first member 56 includes a connection portion 56a and a shaft portion 56b. The connection portion 56a is, for example, a portion connected to the second member 58. In this embodiment, the connection portion 56a is disc-shaped. The connection portion 56a is accommodated within a recess 582 of the second member 58. The shaft portion 56b is, for example, a portion connected to the negative electrode current collecting terminal 52. In this embodiment, the shaft portion 56b is cylindrical. The shaft portion 56b extends from the connection portion 56a. The shaft portion 56b is inserted into the through hole 52h of the negative electrode current collecting terminal 52.

The first member 56 is, for example, made of a first metal. The first metal is, for example, aluminum, an aluminum alloy (an alloy containing at least 70 mass % aluminum based on the total ingredients, the same applies hereinafter), copper, or a copper alloy. The first metal and the second metal described below may be the same or different metals, but no limitation is intended. When the first metal and the second metal are different metals, the first metal is preferably copper or a copper alloy.

The second member 58 is, for example, a portion where the busbar 14 is welded. In this embodiment, the second member 58 is plate-shaped. The second member 58 is arranged along an outer face 32u of the sealing plate 32. As shown in FIG. 2, in the second member 58, the recess 582, which is a non-through hole, is formed in a first face 581 in the thickness direction. The recess 582 accommodates the connection portion 56a of the first member 56, and a peripheral portion of the connection portion 56a is crimped to an inner wall face of the recess 582. Here, the phrase “peripheral edge of the connection portion 56a of the first member 56 is crimped to an inner wall face of the recess 582” means that the first member 56 is fixed to the second member 58 by, for example, the peripheral edge of the connection portion 56a of the first member 56 being pressed against the inner wall face of the insertion hole 582. A second face 584 of the second member 58 in the thickness direction is a flat face. In this embodiment, the busbar 14 is welded to the second face 584.

In this embodiment, the second member 58 has a space 58S between the second member 58 and the first member 56. The space 58S is, in this case, a space where gas can accumulate. In the configuration shown in FIG. 2, the space 58S is formed between an inner wall of the recess 58 and the connection portion 56a of the first member 56 accommodated within the recess 58. For example, if the upper end face of the connection portion 56a is recessed, the space 58S may be formed between the connection portion 56a and the inner wall face of the recess 58.

As shown in FIG. 2, the second member 58 has a ventilation hole 58h. The ventilation hole 58h is, for example, a through hole that communicates the space 58S with outside air. The ventilation hole 58h is provided at a position where it can communicate with a through hole 14h of the busbar 14, which will be described later. The size, planar shape, and the like of the ventilation hole 58h are not particularly limited and may be appropriately set as long as they can achieve the effects of the technology disclosed herein.

The second member 58 is, for example, made of a second metal. The second metal may be, for example, aluminum, an aluminum alloy, copper, or an alloy primarily composed of copper. When the first metal and the second metal are different metals, the second metal is preferably aluminum or an aluminum alloy.

The positive terminal 40 may have the same structure as the negative terminal 50. Therefore, the description of the structure of the positive terminal 40 is omitted here. The positive terminal 40 is preferably composed of aluminum or an aluminum alloy as a whole.

As shown in FIG. 2, the power storage device 12 includes an insulating member 60. The insulating member 60 is, for example, a member that insulates between the negative external terminal 54 and the sealing plate 32, and between the sealing plate 32 and the negative electrode current collecting terminal 52. In this embodiment, the insulating member 60 is disposed between the negative external terminal 54 and the outer face 32u of the sealing plate 32, between the negative external terminal 54 and the second through hole 322, and between the inner face 32d of the sealing plate 32 and the negative electrode current collecting terminal 52. The material used to form the insulating member 60 may be any material that is typically used as an insulating member in power storage devices of this type (e.g., lithium-ion secondary batteries) without any particular restriction. The insulating member 60 may be integrally formed to achieve the above functions or may be formed by combining multiple parts. Although not shown in the drawings, the power storage device 12 also includes a similar insulating member on the positive electrode side.

The busbar 14 is a member that electrically connects two adjacent power storage devices 12. In this embodiment, the busbar 14 is plate-shaped. As shown in FIG. 2, the busbar 14 has a through hole 14h. The size, planar shape, and the like of the ventilation hole 58h are not particularly limited and may be appropriately set as long as they achieve the effects of the technology disclosed herein. The busbar 14 is, for example, made of aluminum or an aluminum alloy.

As shown in FIG. 1, the busbar 14 spans across two adjacent power storage devices 12 in the arrangement direction P. In this embodiment, the busbar 14 spans across the positive terminal 40 of one of the two adjacent power storage devices 12 in the arrangement direction P and the negative terminal 50 of the other adjacent power storage device 12.

FIG. 3 is a view of the busbar 14 as viewed from the upper face 141 side. As shown in FIGS. 2 and 3, the busbar 14 is mounted on the negative external terminal 54. In the configuration shown in FIGS. 2 and 3, the busbar 14 is mounted on the second face 584 of the second member 58. In this embodiment, the through holes 14h of the busbar 14 and the ventilation hole 58h of the second member 58 are aligned. As a result, the space 58S is in communication with the outside air.

In this embodiment, the busbar 14 is welded to the positive terminal 40 of one of the two adjacent power storage devices 12 in the arrangement direction P and to the negative terminal 50 of the other adjacent power storage device 12. In the configurations shown in FIGS. 2 and 3, the busbar 14 is welded to the negative external terminal 54 (welded portions 14a). The busbar 14 is welded to the second member 58. The means for welding the electrode terminal to the busbar 14 include, for example, laser welding or resistance welding. From the perspective of improving weld strength, laser welding is preferred.

As shown in FIG. 3, the second member 58 and the busbar 14 are welded in a periphery of the ventilation hole 58h. In the configuration shown in FIG. 3, when viewed with the first face 30a as the front, the welded portions 14a are formed to the left (L) and right (R) of the ventilation hole 58h, respectively. Note that the welded portions 14a may be formed anywhere in a periphery of the ventilation hole 58h. In other embodiments, the welded portions 14a may be formed both above (U) and below (D) the ventilation hole 58h. Alternatively, the welded portions 14a may be formed in a ring-shaped manner surrounding the ventilation hole 58h.

As shown in FIG. 1, in the power storage module 100, the power storage devices 12 are constrained in the arrangement direction P. The power storage module 100 includes a spacer 11 and a pair of end plates 17. The spacer 11 is disposed between the adjacent power storage devices 12 in the arrangement direction P. The end plates 17 are arranged at either end of the power storage devices 12 arranged in the arrangement direction P, restricting the power storage devices 12. The end plates 17 are bridged by metal restricting bands 18. The ends of the restricting bands 18 are fixed by screws 19.

As described above, the metal member (here, the negative terminal 50) includes a first member 56 made of metal and a second member 58 made of metal. The second member 58 is laid on top of the first member 56. The second member 58 has a space 58S between the second member 58 and the first member 56, where gas can accumulate. The second member 58 has ventilation hole 58h that communicates the space 58S with outside air.

In other words, the metal member (here, the negative terminal 50) includes the space 58S between the first member 56 and the second member 58, which are laid on top of each other. Here, the second member 58 has the ventilation hole 58h that communicates the space 58S with outside air. As a result, when welding another metal member to the metal member, for example, gas (e.g., air) in the space 58S that has been made to expand by the heat applied during welding is discharged into outside air through the ventilation hole 58h. This lowers the internal pressure in the space 58S, thereby reducing the risk of molten metal (e.g., molten second member 58) splattering onto the surrounding area.

The second member 58 may have the non-through recess 582 formed in the first face 581. A portion of the first member 56 (here, the connection portion 56a) may be accommodated inside the recess 582. The space 58S is formed between the inner wall of the recess 582 and the portion of the first member 56 accommodated inside the recess 582. In the space 58S formed between the inner wall of the recess 582 and the portion of the first member 56 (here, the connection portion 56a) accommodated in the recess 582, the internal pressure due to gas expansion tends to increase. Therefore, by providing the ventilation hole 58h that communicates the space 58S with outside air, the effects of the technology disclosed herein can be more effectively achieved.

The metal constituting the first member 56 and the metal constituting the second member 58 may be different from each other. Thus, the first member 56, which serves as a connection member with the negative electrode current collecting terminal 52 that collects currents from the negative electrode of the electrode body, and the second member 58, which serves as a connection member with the busbar 14, may be made of different metals. As a result, the electrical conductivity between the electrode body, the negative terminal 50, and the busbar 14 can be improved.

The metal member (here, the negative terminal 50) may further include a third member made of metal (here, the busbar 14). The third member may be placed on the surface of the second member 58 and may be welded to the second member 58. As described above, since the second member 58 includes the ventilation hole 58h, the internal pressure in the space 58S can be lowered. As a result, even when welding the third member to the second member 58, the risk of molten metal (e.g., molten second member 58) splattering onto the surrounding area can be reduced.

The second member 58 and the third member (here, the busbar 14) may be welded in a periphery of the ventilation hole 58h. As a result, heat is applied around the ventilation hole 58h, which serves as a port for discharging gas from the space 58S during welding. As a result, gas can be more efficiently discharged from the space 58S.

The third member (here, the busbar 14) may have the through hole 14h. The ventilation hole 58h of the second member 58 and the through hole 14h of the third member may be in communication with each other. By making the through hole 14h and the ventilation hole 58h in communication with each other, gas can be more efficiently discharged from the space 58S.

As described above, the power storage device 12 includes the negative terminal 50.

By providing the negative terminal 50, gas can be efficiently discharged from the space 58S to outside air when the busbar 14 is welded to the negative terminal 50. This reduces the risk of molten metal (e.g., molten second member 58) splattering onto the surrounding area when welding the busbar 14 to the power storage device 12. Further, the power storage module 100 has improved welding quality between the electrode terminal and the busbar 14.

The power storage module 100 includes the negative terminal 50 including the first member 56 and the second member 58 as electrode terminals. The busbar 14 includes a third member to be welded to the metal member including the first member 56 and the second member 58. As a result, when the busbar 14 is welded to the power storage device 12, the risk of molten metal (e.g., molten second member 58) splattering onto the surrounding area is reduced. This improves the welding quality between the electrode terminals and the busbar 14 in the power storage module 100.

The technology disclosed herein may include the technology described in the following items.

### Item 1:

A metal member comprising:
a first member made of metal; and
a second member made of metal, the second member laid on top of the first member, wherein the second member has:
a space, in which gas can accumulate, between the first member and the second member; and
a ventilation hole that communicates the space with outside air.

### Item 2:

The metal member according to Item 1, wherein
the second member includes a first face in which a non-through hole recess is formed,
a portion of the first member is accommodated in the recess, and
the space is generated between an inner wall of the recess and the portion of the first member accommodated in the recess.

### Item 3:

The metal member according to Item 1 or 2, wherein a metal constituting the first member and a metal constituting the second member are different.

### Item 4:

The metal member according to any one of Items 1 to 3, further comprising a third member made of metal, wherein
the third member is configured to be placed on a surface of the second member and be welded to the second member.

### Item 5:

The metal member according to Item 4, wherein the second member and the third member are welded together in a periphery of the ventilation hole.

### Item 6:

The metal member according to Item 4 or 5, wherein
the third member has a through hole, and
the ventilation hole of the second member and the through hole of the third member are in communication with each other.

### Item 7:

An electrode terminal for use in a power storage device, the electrode terminal comprising the metal member according to any one of Items 1 to 3.

### Item 8:

A power storage module including an electrode terminal and a busbar, the power storage module comprising:
the metal member according to any one of Items 4 to 6, wherein
the electrode terminal includes the first member and the second member,
the busbar includes the third member.

Specific examples of the technology disclosed herein have been described in detail above, but these are merely examples and do not limit the scope of the claims. The technology described in the claims includes various modifications and changes of the specific examples illustrated above.

What is claimed is:

1. A metal member comprising:
a first member made of metal; and
a second member made of metal, the second member laid on top of the first member, wherein the second member has:
a space, in which gas can accumulate, between the first member and the second member; and
a ventilation hole that communicates the space with outside air.

2.
The metal member according to claim 1, wherein
the second member includes a first face in which a non-through hole recess is formed,
a portion of the first member is accommodated in the recess, and
the space is generated between an inner wall of the recess and the portion of the first member accommodated in the recess.

3. The metal member according to claim 1, wherein
a metal constituting the first member and a metal constituting the second member are different.

4.
The metal member according to claim 1,
further comprising a third member made of metal, wherein
the third member is configured to be placed on a surface of the second member and be welded to the second member.

5.
The metal member according to claim 4, wherein the second member and the third member are welded together in a periphery of the ventilation hole.

6. The metal member according to claim 4, wherein
the third member has a through hole, and
the ventilation hole of the second member and the through hole of the third member are in communication with each other.

7. An electrode terminal for use in a power storage device, the electrode terminal comprising the metal member according to claim 1.

8. A power storage module including an electrode terminal and a busbar, the power storage module comprising:
the metal member according to claim 4, wherein
the electrode terminal includes the first member and the second member,
the busbar includes the third member.
